(19) United States
(12) Patent Application Publication
(10) Pub. No.: US 2007/0238409 A1
(43) Pub. Date: Oct. 11, 2007

(54) Method and system for seeking preferred broadcasting stations and media

(76) Inventor: Douglas A. Srail, Kokomo, IN (US)

Correspondence Address: DELPHI TECHNOLOGIES, INC., M/C 480-410-202, PO BOX 5052, TROY, MI, 48007, US

(21) Appl. No.: 11/399,894

(22) Filed: Apr. 7, 2006

(51) Int. Cl. H04H 9/00

(52) U.S. Cl. 455/2.01

(57) ABSTRACT

A system and method is provided for locating media preferred by a listener among a numerous selection of stations from radio broadcasting, satellite radio broadcasting, television broadcasting and media storage devices. An algorithm tracks time and number of timed occurrences that a station having media is listened to by a listener, and establishes a predetermined number of stations favored by the listener. A memory device stores and continuously updates the favored stations. A seeking function presents the favored stations to the listener, enabling the listener to select a preferred station from the presented favored stations. In an aspect, the favored stations are presented to the listener in an order from most listened station to least listened station. In an aspect, the favored stations are categorized according to subject such as news, traffic, weather, sports and music. In an aspect, favored stations are stored for more than one listener.

### FIELD OF THE INVENTION

The invention relates generally to integrated media, and more particularly to locating media preferred by a listener among a numerous selection of stations presented by radio broadcasting, television broadcasting and media storage devices.

### BACKGROUND OF THE INVENTION

Currently, a radio listener is able to select from a number of broadcast stations using a tune button, seek button or scan button. The tune function is utilized to tune to all frequencies throughout either AM signals or FM signals. The seek and scan functions of a radio sequentially tune to the next consecutive strong signal. The seek function must be continuously engaged by a listener to set to the next sequentially strong signal, whereas the scan function continues to search for the next sequentially strong signal but incorporates a delay for the listener to hold a signal thereby discontinuing a search of the next strong signal. Additionally, a listener may manually program a limited number of station presets and may be able to seek and scan through them as well.

Satellite radio, which is now also available to radio listeners, offers an unprecedented number of stations to subscribers. Consequently, since such a numerous selection of stations are available, only a percentage are routinely tuned into by a satellite radio listener. The typical tune function therefore would have to be engaged numerous times to progress through the many stations. This presents an inconvenience and in some cases a hazard due to driver distraction, if the listener is operating a motor vehicle. Also, in the case of satellite radio, all radio signals are received at approximately the same strength and thus utilizing a seek or scan function is equivalent to utilizing a tune button, providing little or no added use to a listener. Engaging a seek button with satellite radio (like a tune function) requires an exhausting level of user action to sequentially progress through the numerous stations, making the conventional seek button of minimal use. Similarly, engaging the scan button requires the user to wait a potentially unacceptably long time while several undesirable stations are sequentially selected until a desired station is found.

Further, while station preset functions are customarily available with most radios, the user must define or program the presets, which are typically limited to about six stations per radio band. The station presets therefore provides an unsatisfactory number of user defined presets in view of the numerous stations offered by satellite radio.

### SUMMARY OF THE INVENTION

A system and method is provided for locating media preferred by a listener among a numerous selection of stations from radio broadcasting, television broadcasting and media storage devices. The present invention is especially useful when numerous broadcasting channel options are presented and unchanged over a vast geographical area (i.e., the U.S.A.), such as with satellite radio.

Favored stations are presented to a listener, and the listener selects a preferred station from the favored stations presented. In an embodiment, the favored stations are categorized for listener selection, according to subject such as news, traffic, weather, sports and music. The favored stations can also be presented to the listener in an order from most listened station to least listened station. In an embodiment, the favored stations are continuously updated with listener use, although the updating can be paused by listener command. Further, a listing of favored stations can be cleared by a listener clear command. Favored stations can also be stored for more than one listener.

Features of the invention are achieved in part, in an embodiment, by employing an algorithm to track at least one of time that a station having media is listened to by a listener and number of timed occurrences that the station having media is listened to by the listener. The algorithm establishes a predetermined number of stations favored by the listener, based at least on one of the time and the number of timed occurrences that the station is listened to by the listener. A memory device then stores the favored stations. In an embodiment, the memory device utilizes EEPROM. A seeking function presents the favored stations to the listener, and enables the listener to select a preferred station from the presented favored stations.

In an embodiment, a receiver is utilized to receive media being transmitted via a radio frequency (RF) signal having a multitude of stations. Embodiments of the invention are incorporated with a conventional receiver having a number of components. The receiver components include an antenna to receive the RF signal, a low noise amplifier to strengthen the RF signal received from the antenna, and a first filter to receive the RF signal and filter out superfluous noise. Additional receiver components include an oscillator to generate a wave at a predetermined frequency and a mixer to mix the oscillator wave and the RF signal to produce an IF signal and separate information in the RF signal from a carrier wave. Additionally included are an IF amplifier to amplify the IF signal, a second filter to filter out unwanted frequency from the mixer, recovering a baseband signal from the IF signal, and a demodulator to convert the information in the RF signal into an original broadcast form.

Other features and advantages of this invention will be apparent to a person of skill in the art who studies the invention disclosure. Therefore, the scope of the invention will be better understood by reference to an example of an embodiment, given with respect to the following figures.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective view of an entertainment system including a radio and CD, in which the present invention is useful;

FIG. 2 is a diagrammatic sectional view illustrating a system to locate media preferred by a listener, in accordance with an embodiment of the present invention;

FIG. 3 is a block diagram of receiver components that is utilized by the system of FIG. 2, in accordance with an embodiment of the present invention;

FIG. 4 illustrates a method to locate media preferred by a listener, in accordance with an embodiment of the present invention;

FIG. 5A is a logic diagram illustration of a time tracking method employed by the algorithm shown in FIG. 2, in accordance with an embodiment of the present invention; and

FIG. 5B is a logic diagram illustration of a presentation and selection method employed by the seeking function shown in FIG. 2, in accordance with an embodiment of the present invention.

### DETAILED DESCRIPTION OF THE INVENTION

Exemplary embodiments are described with reference to specific configurations. Those of ordinary skill in the art will appreciate that various changes and modifications can be made while remaining within the scope of the appended claims. Additionally, well-known elements, devices, components, methods, process steps and the like may not be set forth in detail in order to avoid obscuring the invention. Further, unless indicated to the contrary, any numerical values set forth in the following specification and claims are approximations that may vary depending upon the desired characteristics sought to be obtained by the present invention.

A system and method is described herein for locating media preferred by a listener among a numerous selection of stations from radio broadcasting, television broadcasting and media storage devices. The present invention is especially useful when numerous broadcasting channel options are offered and remain unchanged over a vast geographical area (i.e., the U.S.A.), such as with satellite radio. Further, in reading the Description herein, it is to be appreciated that the present invention can be utilized with broadcasting including amplitude modulation (AM) broadcasting, frequency modulation (FM) broadcasting, satellite radio broadcasting, cable television broadcasting, satellite television broadcasting, and media storage devices such as the iPod™.

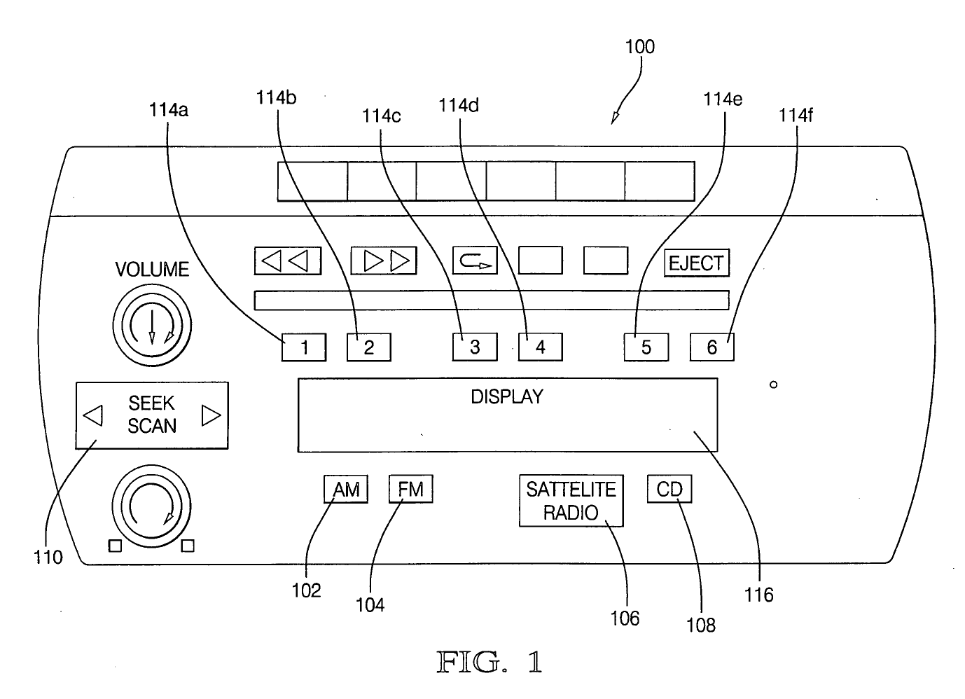

Referring to the drawings wherein identical reference numerals denote the same elements throughout the various views, FIG. 1 illustrates a conventional entertainment system including a radio and CD, in which the present invention is useful. Entertainment system 100 represents the kind typically installed in a motor vehicle. An AM function 102, FM Function 104 and CD function 108 are standard features of an entertainment system. Radio stations can customarily be set to a preferred station using station preset functions 114a-114f, which are typically limited to about six stations per radio band. More currently, a motor vehicle entertainment system often additionally includes a satellite radio function 106, allowing a listener additional and many more radio station options. As discussed infra in the Background, when numerous radio station options are offered to a listener (i.e., satellite radio), then the standard station preset functions 114a-114f provide an unsatisfactory number of user defined presets. Further, engaging a seek/scan button 110 when tuned to satellite radio requires an exhausting level of user action or delay to sequentially progress through the numerous stations, making the conventional scan button of minimal use.

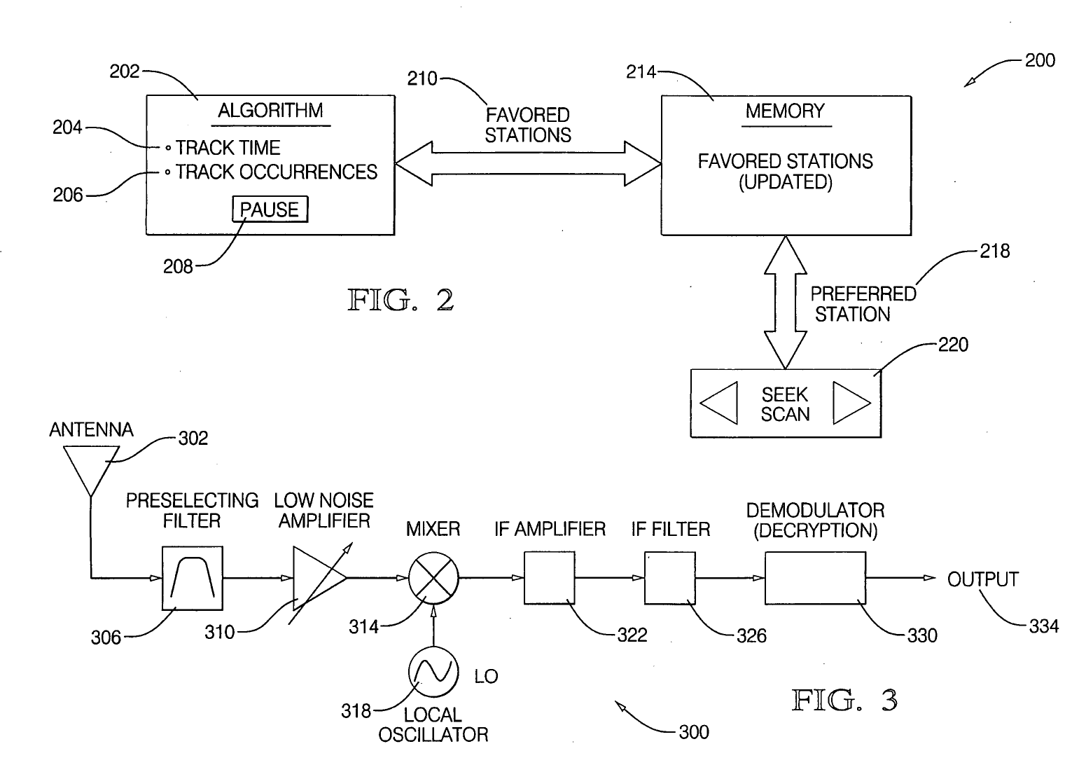

FIG. 2 is a diagrammatic sectional view illustrating a system 200 to locate media selections preferred by a listener, in accordance with an embodiment of the present invention. As used herein, the term media is intended to connote mass communication such as radio broadcasting and television broadcasting, and a device such as a disk on which data is stored.

System 200 employs an algorithm 202 to track at least one of time 204 that a station having media is listened to by a listener and number of timed occurrences 206 that the station having media is listened to by the listener. Timed occurrences 206 are timed so that algorithm 202 only includes station occurrences that occur for a predetermined time. This avoids including transitional stations as favored stations that are momentarily tuned in while a listener makes a selection. For example, when tuning from channel 2 to channel 54, channels in-between may be momentarily selected, and such in-between transitional channels are to be filtered from the favored stations. As used herein, the terms “channel” and “station” are used synonymously. That is, the term “channel” is intended to include a broadcast by television or radio. Similarly, “station” is intended to include a broadcast by television or radio. Further, the terms channel and station are also intended to include tracks, songs or items presented by a media storage device. Also, as used herein, radio means the general process of using radiated electromagnetic energy to carry intelligent messages or programs, including transmissions by satellite or terrestrial means. Algorithm 202 also establishes a predetermined number of favored stations 210 by the listener, based at least on one of the time 204 and the number of timed occurrences 206 that a station is listened to by the listener. The established favored stations 210 are continuously updated with listener use. In an embodiment, algorithm 202 pauses updating following a listener pause command 208. The pause command 208 is useful when, for example, a child is present and wishes to listen to radio station in a vehicle normally occupied by only a parent.

Memory device 214 stores the favored stations 210 subsequent to algorithm 202 establishing favored stations 210. The memory device 214 is continuously updating with listener use. In an embodiment, memory device 214 utilizes an electrically erasable programmable read-only memory (EEPROM). Other types of memory can alternatively be utilized. In an embodiment, the favored stations 210 are personalized by memory device 214 storing favored stations for more than one listener. In an embodiment the number of favored stations is selected by the listener. Further, a listing of favored stations can be cleared by a listener clear command.

A seeking function 220 presents the favored stations 210 to the listener, and enables the listener to select a preferred station 218 from the presented favored stations 210. In an entertainment system such as entertainment system 100 of FIG. 1 infra, the seeking function 220 is a simple pressed button. In an embodiment, the favored stations 210 are presented to the listener in an order from most timed occurrences listened to least number of timed occurrences listened. In another embodiment, the favored stations 210 are presented to the listener in an order from most time listened to least time listened to by a listener. It is to be appreciated that the favored stations 210 can be presented to the listener in an order that is a combination of timed occurrences and time as well. In an embodiment, the favored stations are categorized for listener selection, according to subject such as news, traffic, weather, sports and music.

Referring to FIG. 3, a block diagram of receiver components is illustrated that is utilized by the system of FIG. 2, in accordance with an embodiment of the present invention. In an embodiment, receiver 300 receives media being transmitted via a radio frequency (RF) signal having a multitude of stations. Embodiments of the invention are incorporated with a conventional receiver having a number of components. The receiver components include an antenna 302 to receive the RF signal, a low noise amplifier 310 to strengthen the RF signal received from the antenna 302, and a first preselecting filter 306 to receive the RF signal and filter out superfluous noise. Additional receiver components include an oscillator 318 to generate a wave at a predetermined frequency and a mixer 314 to mix the oscillator wave and the RF signal to produce an IF signal and separate information in the RF signal from a carrier wave. In an embodiment, seeking function 220 varies the signal wave of oscillator 318 to tune into a listener selected channel or station. It is to be appreciated that seeking function 220 can tune into a selection as normally done by a receiver for a conventional tune or seek function. Additionally included are an IF amplifier 322 to amplify the IF signal, a second filter 326 (an IF filter) to filter out unwanted frequency from the mixer 314, recovering a baseband signal from the IF signal, and a demodulator 330 to convert the information in the RF signal into an original broadcast form 334. A decryption system is also employed when receiving satellite radio.

In the case of an FM receiver, a limiter is used prior to the second filter 326 to limit the amplitude of the input signal to an output with a constant minimum value, thereby minimizing amplitude variations caused by noise. Subsequent to the second filter 326, a squelch is used to deactivate the baseband amplifier when no station signal is present, thereby precluding a listener from hearing a constant noise output when a signal is not present. Also, varying the oscillator 318 tunes in the station desired.

Embodiments of the invention can be used with AM radio broadcasting having a low frequency (LF) between 20 and 300 KHz, a medium frequency (MF) between 300 and 3,000 KHz, and a high frequency (HF) between 3 and 30 MHz. Additionally, embodiments of the invention can be used with FM radio broadcasting having a very High Frequency (VHF) between 30 and 300 MHz. Further, embodiments of the invention can be used with television broadcasting having a very high frequency (VHF) between 30 and 300 MHz, and an ultra high Frequency (UHF) between 300 and 3,000 MHz.

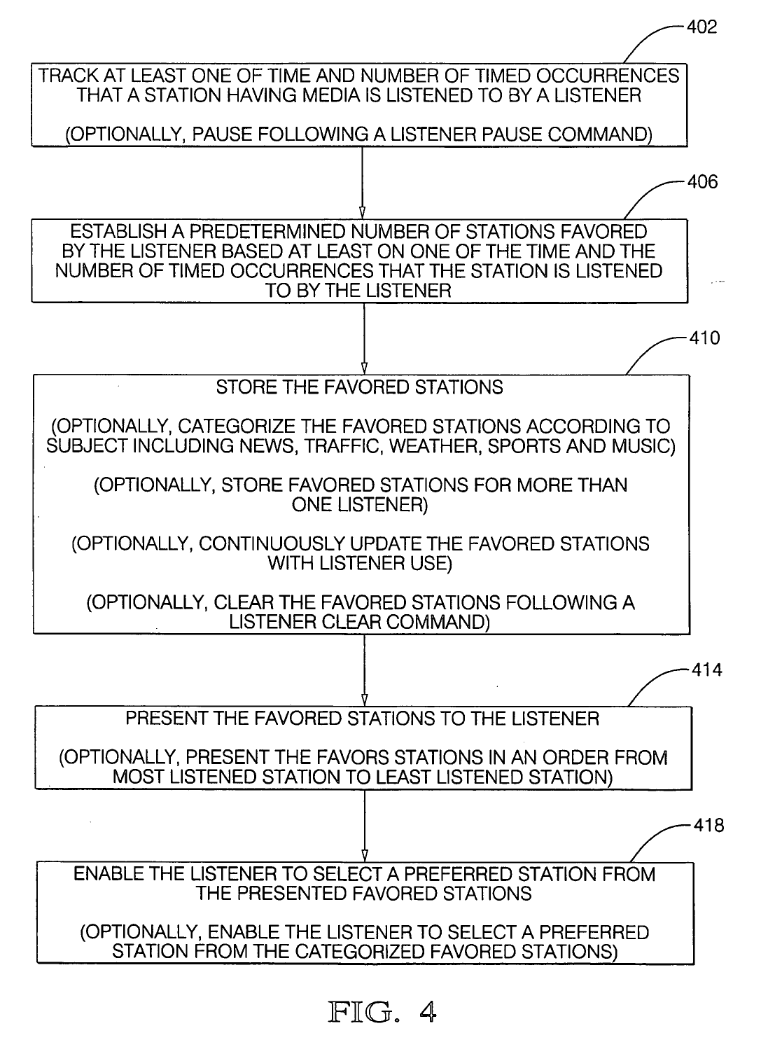

FIG. 4 illustrates a method to locate media preferred by a listener, in accordance with an embodiment of the present invention. Per method step 402, at least one of time that a station having media is listened to by a listener and number of timed occurrences that a station having media is listened to by a listener is tracked. In an embodiment, the time and timed occurrences tracking is paused following a listener pause command. Per method step 406, a predetermined number of stations favored by the listener is established, based at least on one of the time and the number of timed occurrences that the station is listened to by the listener. Per method step 410, the favored stations are stored. In an embodiment, the favored stations are categorized according to subject such as news, traffic, weather, sports and music. In an embodiment, the favored stations are stored for more than one listener. In an embodiment, the favored stations are continuously updated with listener use. In an embodiment, the favored stations are cleared following a listener clear command. Per method step 414, the favored stations are presented to the listener. In an embodiment, the favored stations are presented to the listener in an order from most listened station to least listened station. Further, per method step 418, the listener is enabled to select a preferred station from the presented favored stations. In an embodiment, the listener is enabled to select a preferred station from the categorized favored stations.

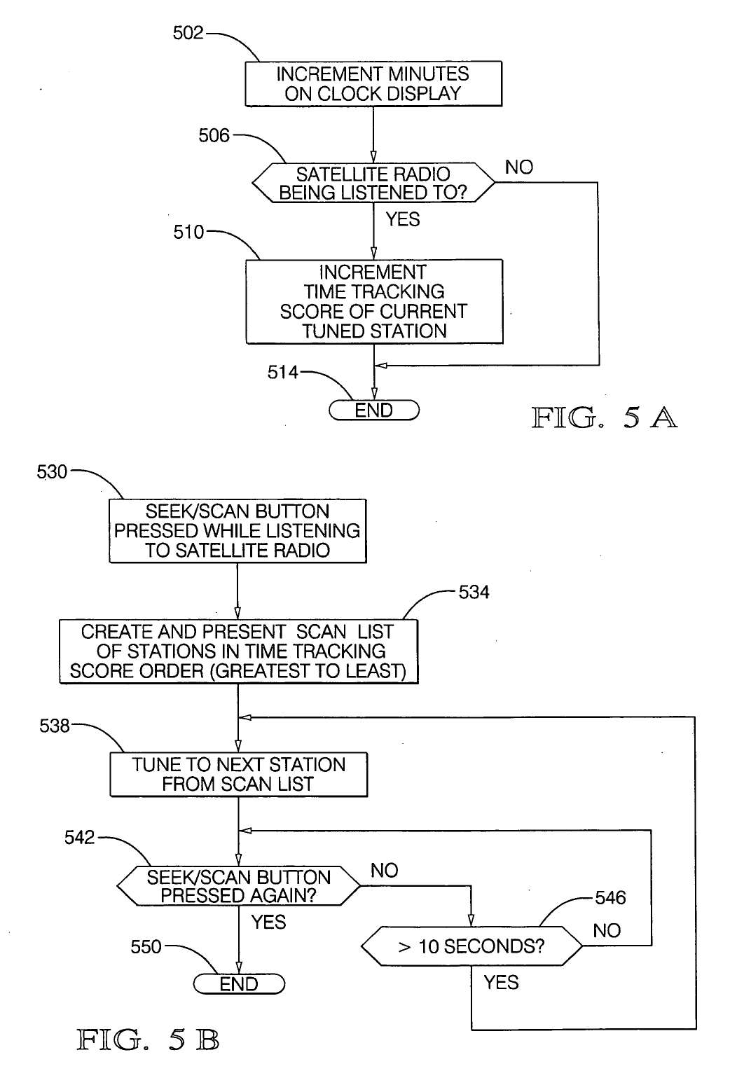

FIG. 5A is a logic diagram illustration of a time tracking method employed by the algorithm 202 shown in FIG. 2, in accordance with an embodiment of the present invention. Method 502 represents a clock display incrementing minutes. Decision 506 represents a query by algorithm 202 (FIG. 2) whether satellite radio is being listened to by a listener. If decision 506 is found to be affirmative, then the time tracking score of the currently tuned radio station is incremented up, per method 510. If decision 506 is found to be negative, then the time tracking score of the currently tuned radio station is not incremented up, per method 514.

FIG. 5B is a logic diagram illustration of a presentation and selection method employed by the seeking function shown in FIG. 2, in accordance with an embodiment of the present invention. Method 530 represents a listener engaging the seek/scan function when listening to satellite radio. Method 534 represents creating and presenting a list of stations in a time tracking score order from greatest to least, wherein time tracking score refers to method 510 of FIG. 5A. Method 538 represents automatically presenting the next station from the list of stations. Decision 542 represents a query whether the seek/scan function is engaged by a listener yet again. If the seek/scan function is engaged again, then the station currently presented remains presented. If the seek/scan function is not engaged again, then the method advances to decision 546 representing a query whether greater than 10 seconds has elapsed since the seek/scan function was previously engaged by a listener. If decision 546 is affirmative, then method 538 is returned and the next station from the list is automatically presented. If decision 546 is negative, then decision 542 is returned representing a query whether the seek/scan function is engaged yet again.

Other features and advantages of this invention will be apparent to a person of skill in the art who studies this disclosure. For example, it is to be appreciated that the present invention can be utilized with other systems, whether or not received by radio frequency, in which numerous selectable options are offered. Thus, exemplary embodiments, modifications and variations may be made to the disclosed embodiments while remaining within the spirit and scope of the invention as defined by the appended claims.

I claim:

1. A system to locate a broadcasting station preferred by a listener comprising:
a receiver to receive a radio frequency (RF) signal having a multitude of stations;
an algorithm to track at least one of time that a station from the receiver having media is listened to by the listener and number of timed occurrences that the station from the receiver having media is listened to by the listener, and to establish a predetermined number of stations favored by the listener, based at least on one of the time and the number of timed occurrences that the station is listened to by the listener;
a memory device to store the favored stations; and
a seeking function to present the favored stations to the listener, and enable the listener to select a preferred station from the presented favored stations, wherein the broadcasting station is transmitted by one of an AM broadcast, an FM broadcast, a satellite radio broadcast, a cable television broadcast, and a satellite television broadcast.

2. The system as in claim 1, wherein the memory device categorizes the favored stations according to subject including news, traffic, weather, sports and music, and wherein the seeking function further enables the listener to select a preferred station from the categorized favored stations.

3. The system as in claim 1, wherein the memory device stores favored stations for more than one listener.

4. The system as in claim 1, wherein the memory device utilizes EEPROM.

5. The system as in claim 1, wherein the memory device continuously updates with listener use of the receiver, wherein the tracking algorithm pauses following a listener pause command, and wherein the memory clears following a listener clear command.

6. The system as in claim 1, wherein the seeking function presents the favored stations to the listener in an order from most listened station to least listened station.

7. The system as in claim 1, wherein the receiver comprises:
an antenna to receive the RF signal;
a low noise amplifier to strengthen the RF signal received from the antenna;
a first filter to receive the RF signal and filter out a superfluous noise;
an oscillator to generate a wave at a predetermined frequency
a mixer to mix the oscillator wave and the RF signal to produce an IF signal and separate information in the RF signal from a carrier wave;
an IF amplifier to amplify the IF signal;
a second filter to filter out an unwanted frequency from the mixer, recovering a baseband signal from the IF signal; and
a demodulator to convert the information in the RF signal into an original broadcast form.

8. A system to locate media preferred by a listener comprising:
an algorithm to track at least one of time that a station having media is listened to by the listener and number of timed occurrences that the station having media is listened to by the listener, and to establish a predetermined number of stations favored by the listener, based at least on one of the time and the number of timed occurrences that the station is listened to by the listener;
a memory device to store the favored stations; and
a seeking function to present the favored stations to the listener, and enable the listener to select a preferred station from the presented favored stations, wherein the media is one of an AM broadcast, an FM broadcast, a satellite radio broadcast, a cable television broadcast, a satellite television broadcast, and a selection from a media storage device.

9. The system as in claim 8, wherein the memory device categorizes the favored stations according to subject including news, traffic, weather, sports and music, and wherein the seeking function further enables the listener to select a preferred station from the categorized favored stations.

10. The system as in claim 8, wherein the memory device stores favored stations for more than one listener.

11. The system as in claim 8, wherein the memory device utilizes EEPROM.

12. The system as in claim 8, wherein the memory device continuously updates with listener use, wherein the tracking algorithm pauses following a listener pause command, and wherein the memory clears following a listener clear command.

13. The system as in claim 8, wherein the seeking function presents the favored stations to the listener in an order from most listened station to least listened station.

14. The system as in claim 8, further including a receiver to provide at least one of the AM broadcast, FM broadcast, satellite radio broadcast, and satellite television broadcast to the listener, and tracked by the algorithm, comprising:
an antenna to receive a radio frequency (RF) signal;
a low noise amplifier to strengthen the RF signal received from the antenna;
a first filter to receive the RF signal and filter out a superfluous noise;
an oscillator to generate a wave at a predetermined frequency.
a mixer to mix the oscillator wave and the RF signal to produce an IF signal and separate information in the RF signal from a carrier wave;
an IF amplifier to amplify the IF signal;
a second filter to filter out an unwanted frequency from the mixer, recovering a baseband signal from the IF signal; and
a demodulator to convert the information in the RF signal into an original broadcast form.

15. A method to locate media preferred by a listener comprising:
tracking at least one of time that a station having media is listened to by the listener and number of timed occurrences that the station having media is listened to by the listener,
establishing a predetermined number of stations favored by the listener, based at least on one of the time and the number of timed occurrences that the station is listened to by the listener;
storing the favored stations;
presenting the favored stations to the listener; and
enabling the listener to select a preferred station from the presented favored stations, wherein the media is one of an AM broadcast, an FM broadcast, a satellite radio broadcast, a cable television broadcast, a satellite television broadcast, and a selection from a media storage device.

16. The method as in claim 15, further comprising categorizing the favored stations according to subject including news, traffic, weather, sports and music, and wherein enabling the listener to select a preferred station comprises enabling the listener to select a preferred station from the categorized favored stations.

17. The method as in claim 15, further comprising storing favored stations for more than one listener.

18. The method as in claim 15, further comprising utilizing EEPROM to store the favored stations.

19. The method as in claim 15, wherein storing the favored stations comprises continuously updating the favored stations with listener use, wherein the tracking pauses following a listener pause command, and wherein the favored stations clear following a listener clear command.

20. The method as in claim 15, further comprising presenting the favored stations to the listener in an order from most listened station to least listened station.
